(19) United States
(12) Patent Application Publication
(10) Pub. No.: US 2004/0169942 A1
(43) Pub. Date: Sep. 2, 2004

(54) Vehicular side mirror having enhanced field of view

(76) Inventor: Johnny G. Smith, Tyler, TX (US)

Correspondence Address: Michael L. Diaz, Michael L. Diaz, P.C., Suite 200, 555 Republic Drive, Plano, TX, 75074, US

(21) Appl. No.: 10/375,424

(22) Filed: Feb. 27, 2003

(51) Int. Cl. G02B 7/182

(52) U.S. Cl. 359/871

(57) ABSTRACT

A vehicular side mirror providing enhanced field of view to a driver. The side mirror includes a first section located adjacent the side of the vehicle. The first section has a substantially planar surface area. Adjacent the first section is a second section. The second section includes a curved surface area providing an enhanced field of view enabling a viewer to view to aft of the vehicle to approximately a 80 degree angular offset from aft of the vehicle.

### BACKGROUND OF THE INVENTION

1. Technical Field of the Invention

This invention relates to mirrors, and more particularly, to a mirror mounted on a door providing enhanced field of vision to a driver.

2. Description of Related Art

Vehicle accidents are a common occurrence and a risk one takes while driving on the roads. One of the primary causes attributed to collision with other vehicles is a lack of awareness by a driver as to the location of other vehicles traveling in close proximity to the driver. To assist drivers in determining where other vehicles are located near the driver's vehicle, mirrors have been employed. Most laws require the use of a rearview mirror mounted on the center portion of the front windshield and two side mirrors mounted on the sides of the front doors of the vehicle. However, it is well known to most drivers that there is one or more “blind spots” which are not visible from the driver's seat with merely referencing the mirrors in the vehicle. To make matters even worse, the “blind spots” may change from the type of vehicle being driven. Cautious drivers should clear the area rearwardly and to the side of the vehicle prior to commencing any turns. However, oftentimes, the driver does not sufficiently clear these “blind spots” prior to turning.

For example, a driver may be traveling in the right line of a two-lane road. A second vehicle may be located in the left land, but in a position slightly aft and to the side of the first vehicle. By merely viewing the areas close to the vehicle through the mirrors, the first vehicle's driver may shift lanes without actually seeing the second vehicle. The geometry of existing mirrors in the vehicle do not provide adequate visibility around the vehicle. The results of not properly clearing the other adjacent lane are obvious, a collision between the first and second vehicles. Automotive mirrors have been modified to provide greater visibility to the driver. It is quite common for a vehicle to have a mirror providing a wider view from the right side mirror. However, these modified mirrors provide wider views at a cost, namely distorted images. Thus, the warning, “objects may be closer than they appear,” explains the disadvantage of such a modified mirror.

FIG. 1 is a top plan view of a first vehicle 10 and a second vehicle 12 utilizing conventional automotive mirrors. Vehicle 10 is traveling in a right lane 14. Vehicle 12 is located in a left lane 16, slightly aft of the vehicle 10. The vehicle 10 includes a rearview mirror 20 and two side mirrors 22 and 24.

The rearview mirror 20 has a specific field of view providing a coverage area 30 of visibility for the driver. The side mirror has a field of view specified as a coverage area 32. In addition, the side mirror 24 has a coverage area 24. The coverage areas are illustrative only and vary with the model and type of vehicle, as well as placement of the mirrors. As illustrated in FIG. 1, the coverage areas provide a limited field of view to the driver of vehicle 10, which is primarily limited to areas directly aft of the vehicle.

When vehicle 12 approaches an area slightly aft and to the side of the vehicle 10, the coverage area of the mirrors 20, 22, and 24 do not provide adequate visibility of the vehicle 12. This “blind spot” may be located on either side of the vehicle 10. If the driver of the vehicle 10 desires to switch lanes to lane 16, the driver references the mirrors. However, the mirrors may not allow a view of the area where the vehicle 12 is located. When the driver changes lanes, a collision may result between vehicles 10 and 12. Although it is prudent for the driver to physically move his head and clear over his shoulder, drivers do not always do this. In addition, some vehicles have blind spots which cannot be seen even when a driver looks over his shoulder.

Modification have been made to existing mirrors. For example, the side mirror 24 has been modified to a “wide angle” allowing a large coverage area. However, this wider range is still not adequate to cover the “blind spots” of the vehicle. Additionally, the wider view of the modified mirror distorts the distances of the vehicles within the mirror. In other cases, typically in large trucks, an extended arm with a larger mirror is employed. Although this extended side mirror provides a greater coverage area, the field of view is primarily enhanced along the rearward portions of the vehicle, which is advantageous for long vehicles, such as trucks with trailers. However, the blind spots located slightly aft and to the side of the vehicle are still not visible. In addition, the use of these extended side mirrors requires the installation of mirror mounts which can be very expensive. A vehicular mirror is needed which provides a wider area of viewing coverage without distorting the images within the mirrors.

Review of existing automotive mirrors reveals no disclosure or suggestion of a vehicular mirror which provides sufficient visibility to view “blind spots” inherent with a vehicle. It is an object of the present invention to provide such an apparatus.

### SUMMARY OF THE INVENTION

In one aspect, the present invention is a side mirror mounted to a side portion of a vehicle. The side mirror includes a first section mounted adjacent the side portion of the vehicle. The first section has a substantially planar surface area. The planar surface area provides a rearward field of view aft of the vehicle. The side mirror also includes a second section adjacent to the first section. The second section has a curved surface area providing a field of view aft and to the side of the vehicle. The first and second sections provide an enhanced field of view ranging from aft of the vehicle to at least a 45 degree angular offset from aft of the vehicle.

In another aspect, the present invention is a side mirror mounted to a side portion of a vehicle. The side mirror includes a first section mounted adjacent the side portion of the vehicle. The first section has a substantially planar surface area. The planar surface area provides a rearward field of view aft of the vehicle. The side mirror also includes a second section adjacent to the first section. The second section has a curved surface area providing a field of view aft and to the side of the vehicle. The first section is affixed adjacent to the second section at a bifurcation point. The first and second sections form a continuous surface having a length and comprising the planar surface area and the curved surface area. The bifurcation point is located at a distance outward from an edge of the first section adjacent the side of the vehicle between two thirds and three fourths of the length of the continuous surface. The first and second sections provide an enhanced field of view ranging from aft of the vehicle to at least a 45 degree angular offset from aft of the vehicle.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a top plan view of a first vehicle and a second vehicle utilizing conventional automotive mirrors;

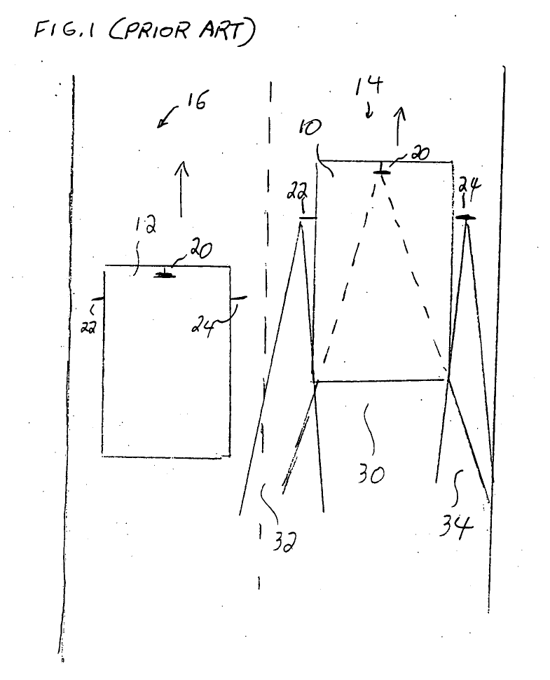

FIG. 2 is a top plan view of a curved side mirror separated from a vehicle in the preferred embodiment of the present invention;

FIG. 3 is a top plan view of a first vehicle utilizing the curved side mirror in the preferred embodiment of the present invention; and

FIG. 4 is a top plan view of a curved side mirror affixed to an existing mirror mount in an alternate embodiment of the present invention.

### DETAILED DESCRIPTION OF EMBODIMENTS

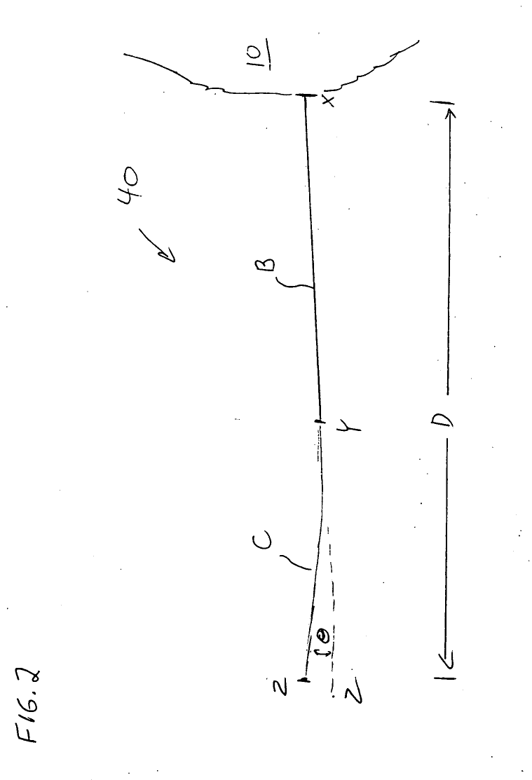

A vehicular mirror providing enhanced visibility is disclosed. FIG. 2 is a top plan view of a curved side mirror 40 separated from a vehicle in the preferred embodiment of the present invention. The side mirror 40 is affixed conventionally to the side of the vehicle 10 at point X. The entire length of the side mirror 40 is a distance D, ranging from point X to a far point Z. A bifurcation point Y is located approximately 2/3 to ¾ of the distance D away from point X. Between X and Y is a segment length B which is substantially straight, in a similar manner as conventional mirrors. Between points Y and Z is a segment length C, which is forwardly curved (curvature θ) to enhance visibility through the mirror through the “blind spot” up to approximately abeam the side mirror 40. The curvature of the segment length C is different for each vehicle. In the preferred embodiment of the present invention, the curvature ranges from ½ of a degree to 3 degrees. However, it should be understood that the curvature of segment length C may be of any degree which enables the driver of the vehicle to see through a wider coverage area than conventional side mirrors. Preferably, the entire length of the side mirror is constructed form one single continuous piece of material. However, in alternate embodiments of the present invention, two or more pieces may be affixed together.

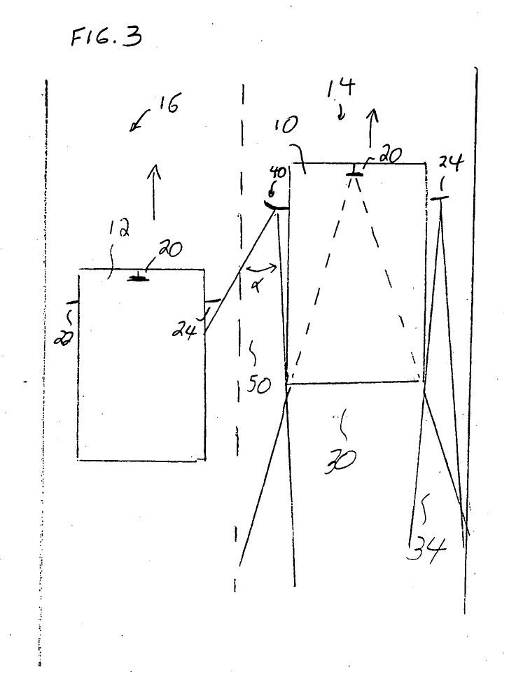

FIG. 3 is a top plan view of a first vehicle 10 utilizing the curved side mirror 40 in the preferred embodiment of the present invention. The vehicle utilizes the curved side mirror 40 to increase the field of vision, thus enabling the driver of the vehicle 10 to see the vehicle 12. The curved mirror provides an enhanced (wider field of vision) coverage area 50. Specifically, the coverage area 50 now provides a field of view from a position directly aft of the vehicle through a position offset at least 45 degrees from aft (an angle α). Preferably, the offset is up to 80 degrees. This coverage area 50 is much wider as compared to the coverage area 32 of the mirror 22. The curvature of the segment length C widens this field of vision.

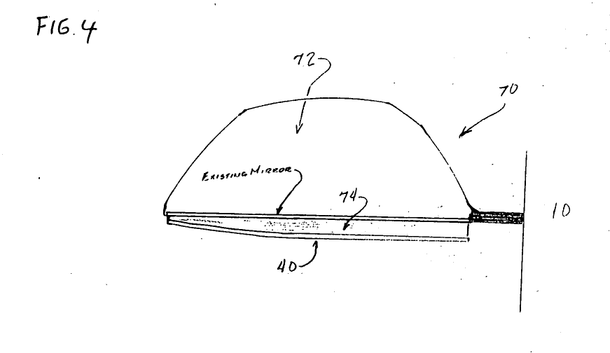

FIG. 4 is a top plan view of a curved side mirror 40 affixed to an existing mirror mount 70 in an alternate embodiment of the present invention. The curved side mirror may be installed on existing vehicles. For example, the vehicle 10 may include an existing mirror mount 70 having an exterior forward casing 72. The existing mirror may be removed and the curved side mirror installed within the mount. Since the curved side mirror is not straight, as with an existing mirror, a filler 74 may be added behind the side mirror and within the exterior forward casing.

The curved mirror may be installed on either side of the vehicle. In addition, in an alternate embodiment of the present invention, the present invention may be any mirror having all or a portion of the mirror curved to allow enhanced visibility. However, in the preferred embodiment of the present invention, the mirror is bifurcated into two sections, a straight section (for viewing immediately aft of the vehicle) and a curved section (for enhanced viewing ranging from aft to sideways from the vehicle).

The present invention provides many advantages over existing side mirrors. The present invention enhances the field of vision of the driver to allow visibility within the “blind spots.” Additionally, the mirror does not require an extended arm mount, as some existing side mirrors used to increase the field of vision. The present invention may be mounted to existing side mirror mounts, thus enabling the present invention to be utilized within any vehicle. The present invention may be customized as necessary to provide curvature of the mirror starting at a specific point Y, based on the desired increase in field of vision.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A side mirror mounted to a side portion of a vehicle, the side mirror comprising:
a first section mounted adjacent the side portion of the vehicle and having a substantially planar surface area, the planar surface area providing a rearward field of view aft of the vehicle; and
a second section adjacent to said first section, said second section having a forwardly curved surface area providing a field of view aft and to the side of the vehicle;
whereby said first and second sections provide an enhanced field of view ranging from aft of the vehicle to at least a 45 degree angular offset from aft of the vehicle.

2. The side mirror mounted of claim 1 wherein the side mirror is mounted on a left side of the vehicle and said first section is located adjacent the left side of the vehicle.

3. The side mirror mounted of claim 1 wherein said first section is affixed adjacent said second section to provide a continuous surface area comprising the planar surface area and the curved surface area.

4. The side mirror mounted of claim 1 wherein the curved surface area has a curvature between one half of a degree and three degrees.

5. The side mirror mounted of claim 1 wherein:
said first section is affixed adjacent said second section at a bifurcation point, said first and second sections forming a continuous surface having a length and comprising the planar surface area and the curved surface area; and
the bifurcation point being located at a distance outward from an edge of the first section adjacent the side of the vehicle between two thirds and three fourths of the length of the continuous surface.

6. The side mirror mounted of claim 1 wherein the side mirror is mounted on a right side of the vehicle and said first section is located adjacent the left side of the vehicle.

7. The side mirror mounted of claim 1 wherein the enhanced field of view ranges from aft of the vehicle to at least an 80 degree angular offset from aft of the vehicle.

8. The side mirror mounted of claim 1 wherein the first and second sections are formed form a singular continuous piece of material.

9. A side mirror mounted to a side portion of a vehicle, the side mirror comprising:
a first section mounted adjacent the side portion of the vehicle and having a substantially planar surface area, the planar surface area providing a rearward field of view aft of the vehicle; and
a second section adjacent to said first section, said second section having a forwardly curved surface area providing a field of view aft and to the side of the vehicle;
said first section is affixed adjacent to said second section at a bifurcation point, said first and second sections forming a continuous surface having a length and comprising the planar surface area and the curved surface area;
the bifurcation point being located at a distance outward from an edge of the first section adjacent the side of the vehicle between two thirds and three fourths of the length of the continuous surface.
whereby said first and second sections provide an enhanced field of view ranging from aft of the vehicle to at least a 45 degree angular offset from aft of the vehicle.

10. The side mirror mounted of claim 9 wherein the curved surface area has a curvature between one half of a degree and three degrees.

11. The side mirror mounted of claim 9 wherein the angular offset provided by the enhanced field of view is at least 80 degrees.
